(19) United States
(12) Patent Application Publication
(10) Pub. No.: US 2008/0145227 A1
(43) Pub. Date: Jun. 19, 2008

(54) METHODS AND APPARATUS FOR LOAD TRANSFER IN ROTOR ASSEMBLIES

(76) Inventors: Mark Stefan Maier, Greer, SC (US); Robert Alan Brittingham, Piedmont, SC (US); Louis Veltre, Simpsonville, SC (US)

Correspondence Address: JOHN S. BEULICK (17851), ARMSTRONG TEASDALE LLP, ONE METROPOLITAN SQUARE, SUITE 2600, ST. LOUIS, MO, 63102-2740, US

(21) Appl. No.: 11/612,977

(22) Filed: Dec. 19, 2006

(51) Int. Cl. H02K 15/02; B63H 1/16; F01D 5/12; F01D 5/22

(52) U.S. Cl. 416/193 R; 29/598; 416/220 R; 29/596; 60/805; 60/641.2

(57) ABSTRACT

A method of assembling a rotor assembly is provided. The method includes coupling a first turbine bucket to a rotor disk wherein the first turbine bucket includes a first tip shroud including a first surface, providing a second turbine bucket that includes a second tip shroud including a second surface, and coupling the second turbine bucket to the rotor disk such that the second turbine bucket is circumferentially adjacent to the first turbine bucket and such that during operation of the rotor assembly the first tip shroud contacts the second tip shroud along the first and second surfaces to enable at least one of a portion of radial loading induced to the first tip shroud to be transferred to the second tip shroud and a portion of radial loading induced to the second tip shroud to be transferred to the first tip shroud.

### BACKGROUND OF THE INVENTION

This invention relates generally to turbine rotor assemblies and more particularly to methods and apparatus for relieving stress at a tip shroud of rotating airfoils used with turbine rotor assemblies.

At least some known turbine rotor assemblies include a plurality of rotor blades or buckets (hereinafter, the term “bucket” shall be used to refer generically to a turbine bucket or an aircraft engine blade) that extend from a root to a tip shroud. Generally, tip shrouds facilitate improving the performance of the turbine rotor assembly. During operation, tip shrouds are subject to high thermal and mechanical loading which induce stresses into the tip shrouds which must be addressed to maintain the useful life of the blade.

To facilitate reducing stresses induced to tip shrouds, at least some known bucket tip shrouds are scalloped such that selected portions of the tip shroud are removed. For example, it is known to remove portions of the tip shroud along the leading edge and/or trailing edge of the tip shroud during a scalloping process. Although the scalloped areas facilitate reducing mechanical loading, and thus stresses, induced to the tip shrouds, scalloping the tip shrouds may adversely affect the performance of the engine.

### BRIEF DESCRIPTION OF THE INVENTION

In one aspect, a method of assembling a rotor assembly is provided. The method includes coupling a first turbine bucket to a rotor disk wherein the first turbine bucket includes a first tip shroud including a first surface, providing a second turbine bucket that includes a second tip shroud including a second surface, and coupling the second turbine bucket to the rotor disk such that the second turbine bucket is circumferentially adjacent to the first turbine bucket and such that during operation of the rotor assembly the first tip shroud contacts the second tip shroud along the first and second surfaces to enable at least one of a portion of radial loading induced to the first tip shroud to be transferred to the second tip shroud and a portion of radial loading induced to the second tip shroud to be transferred to the first tip shroud.

In a further aspect, a rotor assembly is provided. The rotor assembly includes a first turbine bucket including a first tip shroud extending from a radially outer end of the first turbine bucket. The first tip shroud includes a first surface. The rotor assembly also includes a second turbine bucket including a second tip shroud extending from a radially outer end of the second turbine bucket. The second tip shroud is positioned circumferentially adjacent to the first tip shroud. The second tip shroud includes a second surface configured to transfer at least one of a portion of radial loading induced to the second tip shroud to the first tip shroud and a portion of radial loading induced to the first tip shroud to the second tip shroud.

In a further aspect, a turbine bucket assembly is provided. The turbine bucket assembly includes a turbine bucket and a tip shroud extending from a radially outer end of the turbine bucket. The tip shroud includes a leading edge and an opposing trailing edge such that a first circumferential side and an opposing second circumferential side each extend between the leading edge and the trailing edge. The tip shroud further includes at least one tip rail extending between the first and second circumferential side. The turbine bucket assembly also includes a first surface and a second surface each extending along a portion of at least one of the first circumferential side, the at least one tip rail, the leading edge, and the trailing edge. The first and second surfaces are configured to enable radial load transfer from the first tip shroud to an adjacent second tip shroud.

### BRIEF DESCRIPTION OF THE DRAWINGS

FIG. 1 is a perspective view of an exemplary bucket that may be used with an axial flow turbine;

FIG. 2 is a perspective view of a portion of a pair of the buckets shown in FIG. 1 and coupled in position within a turbine rotor assembly;

FIG. 3 is a perspective top view of an exemplary bucket tip shroud shown in FIG. 2; and

FIG. 4 is a perspective bottom view of the bucket tip shroud shown in FIG. 3.

### DETAILED DESCRIPTION OF THE INVENTION

As used herein, an element or step recited in the singular and proceeded with the word “a,” “an,” or “one” (and especially, “at least one”) should be understood as not excluding plural said elements or steps, unless such exclusion is explicitly stated. Furthermore, references to “one embodiment” (or to “other embodiments”) of the present invention are not intended to be interpreted as excluding either the existence of additional embodiments that also incorporate the recited features or of excluding other features described in conjunction with the present invention. Moreover, unless explicitly stated to the contrary, embodiments “comprising” or “having” an element or a plurality of elements having a particular property may include additional such elements not having that property.

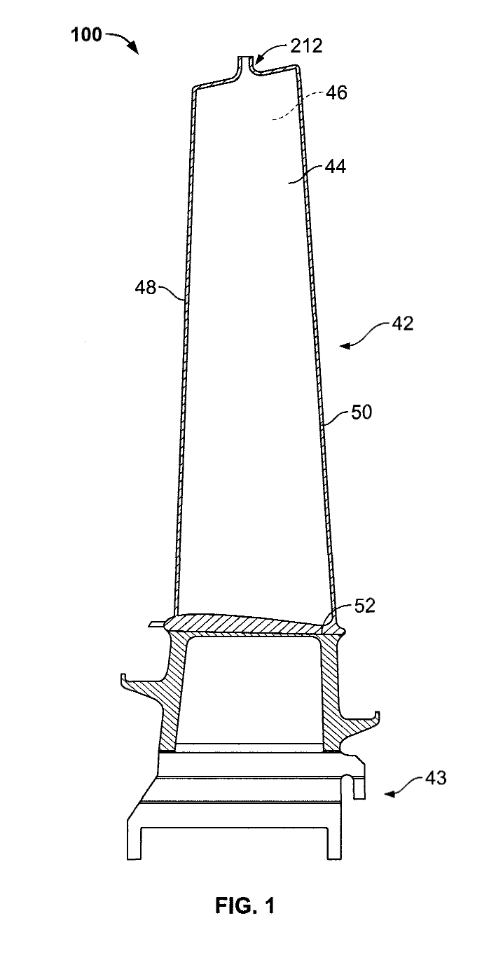

FIG. 1 is a perspective view of a turbine bucket 100 that may be used with an axial flow turbine. In an exemplary embodiment, each bucket 100 includes an airfoil 42 and an integrally-formed dovetail 43 used for mounting airfoil 42 to a rotor disk (not shown).

Airfoil 42 includes a first sidewall 44 and a second sidewall 46. First sidewall 44 is concave and defines a pressure side of airfoil 42, and second sidewall 46 is convex and defines a suction side of airfoil 42. Sidewalls 44 and 46 are connected at a leading edge 48 and at an axially-spaced trailing edge 50 of airfoil 42 that is downstream from leading edge 48.

First and second sidewalls 44 and 46, respectively, extend longitudinally or radially outward to span from a blade root 52 positioned adjacent dovetail 43. In the exemplary embodiment, airfoil 42 and blade root 52 are fabricated as a unitary component. In an alternative embodiment, airfoil 42 and root 52 are not fabricated as a unitary piece. In the exemplary embodiment, bucket 100 includes a tip shroud 212. Bucket 100 is coupled to a rotor shaft and extends radially outward from the rotor shaft. In an alternative embodiment, bucket 100 may be coupled to a rotor shaft by other devices configured to couple a bucket to a rotor shaft, such as, a blisk.

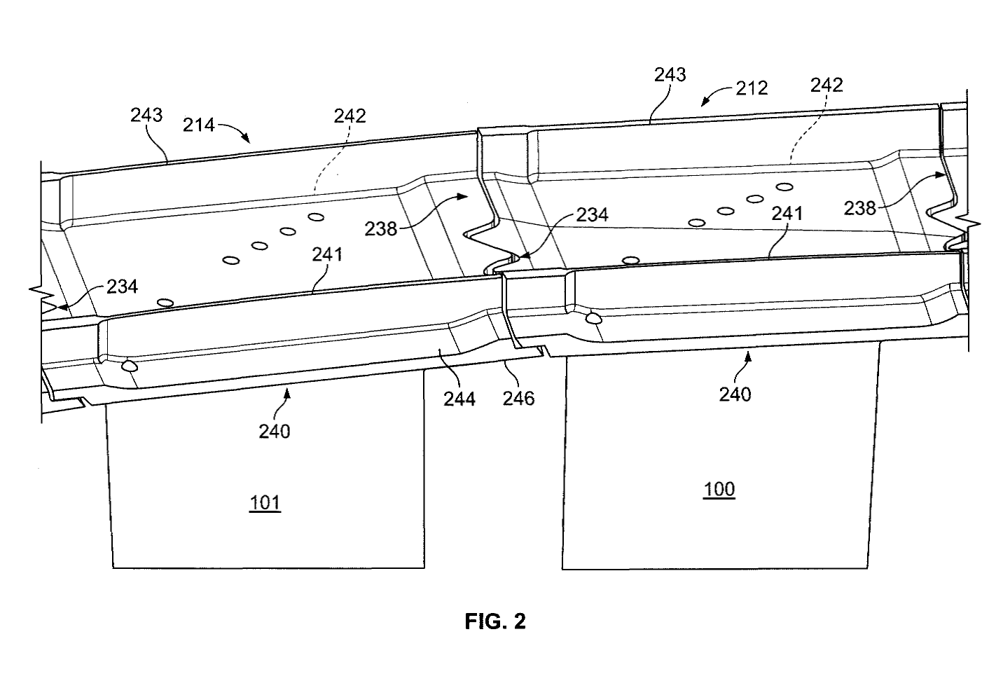

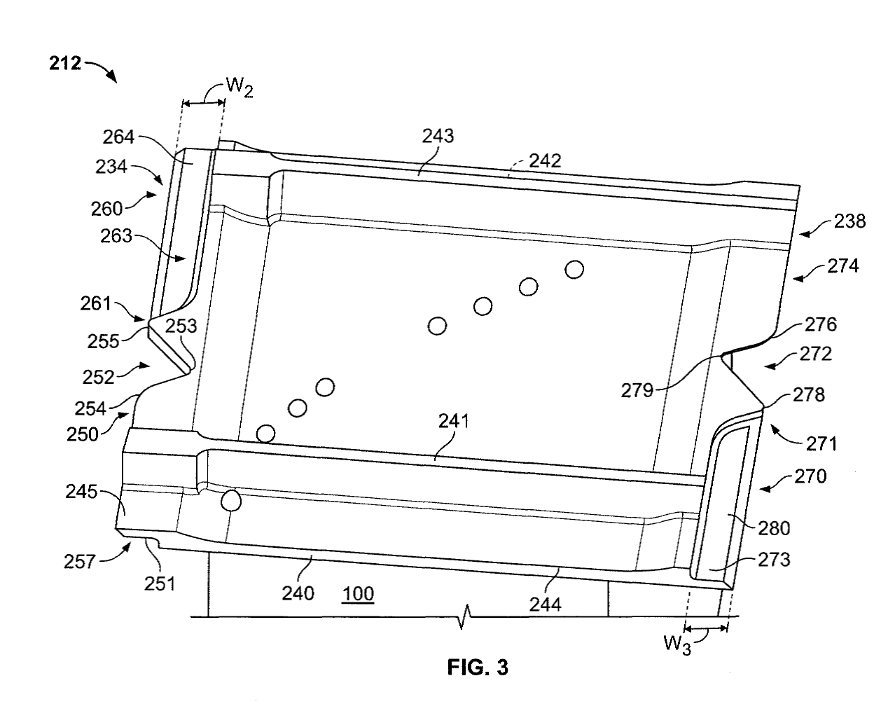

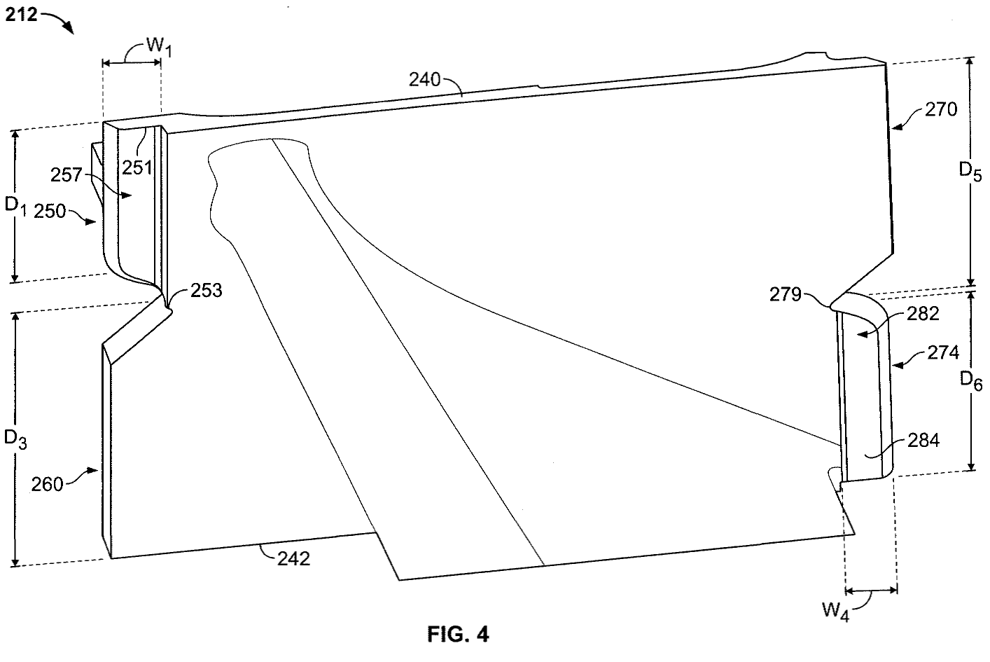

FIG. 2 is a perspective view of a portion of a pair of circumferentially-adjacent buckets 100 and 101 coupled in position within a turbine rotor assembly. FIG. 3 is a perspective top view of tip shroud 212. FIG. 4 is a perspective bottom view of tip shroud 212.

Specifically, in the exemplary embodiment, buckets 100 and 101 are substantially identical and each includes tip shroud 212. For simplicity, a first bucket is identified as bucket 100 and a second bucket is identified as bucket 101. Bucket 100 includes a first tip shroud 212 and bucket 101 includes a second tip shroud 214. As described in more detail below, tip shroud 212 is sized and oriented at the time of manufacture to cooperate and mate against a portion of tip shroud 214. Moreover, as described in more detail below, in the exemplary embodiment, a portion of first tip shroud 212 is configured to support a radial load from second tip shroud 214 that is circumferentially adjacent to first tip shroud 212.

As shown in FIG. 2, each tip shroud 212 and 214 includes a first sidewall 234 and an opposite circumferentially-spaced second sidewall 238 that are connected together via a leading edge side 240 and an opposite trailing edge side 242. In the exemplary embodiment, neither leading edge side 240 nor trailing edge side 242 are scalloped. Leading and trailing edge sides 240 and 242 each extend circumferentially between first and second sidewalls 234 and 238, respectively. In the exemplary embodiment, each tip shroud 212 and 214 includes a pair of tip rails 241 and 243. In an alternative embodiment, each tip shroud 212 and 214 includes one tip rail.

As shown in FIG. 3, in the exemplary embodiment, first sidewall 234 is formed with an overhang portion 250 that is defined along a portion of first sidewall 234. Specifically, in the exemplary embodiment, overhang portion 250 extends from leading edge side 240 towards trailing edge side 242. As shown in FIG. 4, in the exemplary embodiment, overhang portion 250 extends a distance D₁ from leading edge side 240 towards trailing edge side 242. First sidewall 234 is also formed with a notch 252. Specifically, in the exemplary embodiment, notch 252 is defined by a first end 254 and a second end 255 that are connected together at an apex 253. In the exemplary embodiment, notch 252 is a Z-notch that extends continuously from first end 254 to second end 255. As such, in the exemplary embodiment, overhang portion 250 extends from leading edge side 240 to notch first end 254.

Overhang portion 250 is formed by a recess 257 that extends a width W₁ from first sidewall 234 towards second sidewall 238 and along a radially inner surface 251. In the exemplary embodiment, a radially outer surface 245 is offset a distance (not shown) outboard from radially outer surface 244 of leading edge 240. Overhang portion radially inner surface 251 forms a mating surface that enables circumferentially-adjacent tip shrouds 212 and 214 to abut each other, as described in more detail below.

First sidewall 234 is also formed with an undercut portion 260 that extends along a portion of first sidewall 234. Specifically, in the exemplary embodiment, undercut portion 260 extends from trailing edge side 242 towards leading edge side 240. More specifically, in the exemplary embodiment, undercut portion 260 extends a distance D₃ from trailing edge side 242 to apex 253. In an alternative embodiment, undercut portion 260 extends from trailing edge side 242 to a projection 261 is positioned adjacent notch second end 255. In the exemplary embodiment, distance D₃ is approximately equal to distance D₁. In an alternative embodiment, distance D₃ is different than distance D₁.

Undercut portion 260 is defined by a recessed area 263 that extends a width W₂ from first sidewall 234 towards second sidewall 238 and along a radially outer surface 264. Undercut portion radially outer surface 264 forms a mating surface that enables circumferentially adjacent tip shrouds 212 and 214 to abut each other, as described in more detail below.

Second sidewall 238 includes an undercut portion 270, a projection 271, a notch 272, and an overhang portion 274. In the exemplary embodiment, undercut portion 270, notch 272, and overhang portion 274 are formed similarly to undercut portion 260, notch 252, and overhang portion 250 in that each is sized, shaped, and oriented to mate against a respective circumferentially-adjacent overhang portion 250, notch 252, and undercut portion 260. More specifically, in the exemplary embodiment, undercut portion 270 extends from leading edge side 240 towards trailing edge side 242. Specifically, undercut portion 270 extends a distance D₅ from leading edge side 240 towards trailing edge side 242. Specifically, undercut portion 270 extends from leading edge side 240 to an apex 279. Alternatively, undercut portion 270 extends from leading edge side 240 to projection 271. In the exemplary embodiment, distance D₅ is substantially equal to distance D₃ of undercut portion 260. In an alternative embodiment, distance D₅ is different than undercut portion distance D₃. Second sidewall 238 is also formed with a notch 272 that is defined by a first end 276 and a second end 278 that are connected together at apex 279. In the exemplary embodiment, notch 272 is a Z-notch extending continuously from first end 276 to second end 278. As such, in the exemplary embodiment, undercut portion 270 extends from leading edge side 240 to projection 271 near notch second end 278.

Undercut portion 270 is defined by a recessed area 273 that extends a width W₃ from second sidewall 238 towards first sidewall 234 and along shroud a radially outer surface 280. Undercut portion radially outer surface 280 forms a mating surface that enables circumferentially adjacent tip shrouds 212 and 214 to abut each other, as described in more detail below.

Additionally, second sidewall 238 is formed with overhang portion 274 that extends along a portion of second sidewall 238. Overhang portion 274 extends from trailing edge side 242 towards leading edge side 240. In the exemplary embodiment, overhang portion 274 extends a distance D₆ from trailing edge side 242 towards leading edge side 240. In the exemplary embodiment, distance D₆ is substantially equal to distance D₁ of overhang portion 250. In an alternative embodiment, D₆ is different than overhang portion distance D₁. Specifically, overhang portion 274 extends from trailing edge side 242 to first end 276 of notch 272. Overhang portion 274 is formed by a recess 282 that extends a width W₄ from second sidewall 238 towards first sidewall 234 and along a shroud radially inner surface 284. Overhang portion radially inner surface 284 forms a mating surface that enables circumferentially-adjacent tip shrouds to abut each other, as described in more detail below.

In the exemplary embodiment, first sidewall 234 is designed to mate against second sidewall 238 such that a portion of radial loading induced to tip shroud 212 is transferred to tip shroud 214. Specifically, overhang portion 250 is designed to mate against undercut portion 270, and overhang portion 274 is designed to mate against undercut portion 260. In the exemplary embodiment, overhang portions 250 and 274 are designed to ensure overlap with undercut portions 270 and 260, respectively. It should be noted that the orientation and configurations of tip shrouds 212 and 214 is the exemplary embodiment. For example, in an alternative embodiment, neither tip shroud 212 nor tip shroud 214 is formed with overhang portions 250 and 274 or with undercut portions 260 and 270. In an alternative embodiment, tip shroud first sidewall 234 is formed with a first surface that is positionable relative to tip shroud second sidewall 238 to enable the first surface and second surface to contact during operation of the rotor assembly such that a portion of radial loading induced to tip shroud 212 is transferred to tip shroud 214. In another alternative embodiment, for example, at least one of tip shroud 212 and/or tip shroud 214 includes, but is not limited to including, circumferential pins, tabs, and/or any other suitable mechanisms that enables a portion of radial loading induced to tip shroud 212 to be translated to tip shroud 214.

In an alternative embodiment, leading edge 240 includes overhang portion 250 and undercut portion 260, and/or trailing edge 242 includes overhang portion 274 and undercut portion 270 wherein a portion of radial loading induced to tip shroud 212 is transferred to tip shroud 214. In a further alternative embodiment, tip rail 241 includes overhang portion 250 and undercut portion 260, and/or tip rail 243 includes overhang portion 274 and undercut portion 270 wherein a portion of radial loading induced to tip shroud 212 is transferred to tip shroud 214.

During assembly, in the exemplary embodiment, buckets 100 and 101 are positioned circumferentially adjacent one another such that tip shrouds 212 and 214 are positioned circumferentially adjacent to each other. More specifically, when aligned, the leading edge side 240 of tip shroud 212 is substantially circumferentially aligned with the leading edge side 240 of tip shroud 214. As such, first sidewall 234 of tip shroud 212 is positioned circumferentially adjacent second sidewall 238 of tip shroud 214. More specifically, in the exemplary embodiment, when tip shrouds 212 and 214 are adjacent to each other, radially inner surface 251 of overhang portion 250 is aligned with radially outer surface 280 of undercut portion 270, projection 271 is aligned with the walls within notch 252, and apex 279 receives projection 261. Furthermore, radially outer surface 264 of recessed area 263 of undercut portion 260 is aligned with radially inner surface 284 of recess 282 of overhang portion 274. Positioning undercut portions 260 and 270 and overhang portions 250 and 274 in a mating relationship with one another facilitates increasing the useful life of tip shrouds 212 and 214, and thus prevents the inclusion of scallops and/or other weakening cut away portions of tip shrouds 212 and 214. Prior to thermal expansion of buckets 100 and 101, first sidewall 234 of tip shroud 212 is aligned with adjacent second sidewall 238 of tip shroud 214. Tip shrouds 212 and 21 4 are positioned to contact one another during operation of the turbine.

During operation of a turbine, air flows along tip shrouds 212 and 214 and from leading edge 240 towards trailing edge side 242. As tip shrouds 212 and 214 thermally and mechanically expand, overhang portions 250 and 274 facilitate resisting radially outward movement of undercut portions 260 and 270 such that stresses induced to tip shrouds 212 and 214 during turbine operation are reduced. During operation, the combination of overhang portions 250 and 274, and undercut portions 260 and 270, transmit tip shroud centrifugal loading into each corresponding bucket 100 and 101. Specifically, in the exemplary embodiment, a portion of radial loading induced to tip shroud 212 is transferred to tip shroud 214, or a portion of radial loading induced to tip shroud 214 is transferred to tip shroud 212. Moreover, in the exemplary embodiment, a portion of radial loading induced to tip shroud 212 is transferred to tip shroud 214, and a portion of radial loading induced to tip shroud 214 is simultaneously transferred to tip shroud 212. The enhanced radial retention enables a manufacturer to prevent from having to scallop the leading and/or trailing edges of the tip shroud. Additionally, the radial retention facilitates preventing a fillet (not shown) located between the airfoil and tip shroud from being solely responsible for carrying the load of the tip shroud. By reducing and lowering stresses in tip shroud 212 and 214, the useful life of the tip shrouds is facilitated to be increased.

The above-described invention provides an overlapping tip shroud assembly that facilitates reducing stresses induced within the tip shroud. Reducing stresses within the tip shroud facilitates increasing the useful life of the tip shroud white maintaining engine performance.

An exemplary embodiment of a turbine rotor assembly is described above in detail. The assembly illustrated is not limited to the specific embodiments described herein, but rather, components of each assembly may be utilized independently and separately from other components described herein.

While the invention has been described in terms of various specific embodiments, those skilled in the art will recognize that the invention can be practiced with modification within the spirit and scope of the claims.

What is claimed is:

1. A method of assembling a rotor assembly comprising:
coupling a first turbine bucket to a rotor disk wherein the first turbine bucket includes a first tip shroud including a first surface;
providing a second turbine bucket that includes a second tip shroud including a second surface; and
coupling the second turbine bucket to the rotor disk such that the second turbine bucket is circumferentially adjacent to the first turbine bucket and such that during operation of the rotor assembly the first tip shroud contacts the second tip shroud along the first and second surfaces to enable at least one of a portion of radial loading induced to the first tip shroud to be transferred to the second tip shroud and a portion of radial loading induced to the second tip shroud to be transferred to the first tip shroud.

2. A method in accordance with claim 1 further comprises coupling the second turbine bucket to the rotor disk such that the second turbine bucket is circumferentially adjacent to the first turbine bucket and such that during operation of the rotor assembly, the first tip shroud contacts the second tip shroud along the first and second surfaces such that a portion of radial loading induced to the first tip shroud is transferred to the second tip shroud.

3. A method in accordance with claim 1 further comprises coupling the second turbine bucket to the rotor disk such that the second turbine bucket is circumferentially adjacent to the first turbine bucket and such that during operation of the rotor assembly, the first tip shroud contacts the second tip shroud along the first and second surfaces such that a portion of radial loading induced to the second tip shroud is transferred to the first tip shroud.

4. A method in accordance with claim 1 further comprises coupling the second turbine bucket to the rotor disk such that the second turbine bucket is circumferentially adjacent to the first turbine bucket and such that during operation of the rotor assembly, the first tip shroud contacts the second tip shroud along the first and second surfaces such that a portion of radial loading induced to the second tip shroud is transferred to the first tip shroud and a portion of radial loading induced to the first tip shroud is transferred to the second tip shroud.

5. A method in accordance with claim 1 wherein coupling the first turbine bucket to the rotor disk further comprises providing a first tip shroud that includes an undercut portion.

6. A method in accordance with claim 5 wherein providing the second turbine bucket further comprises providing a second tip shroud that includes an overhang portion that is configured to contact the first tip shroud undercut portion during rotor operation.

7. A method in accordance with claim 1 wherein coupling the second turbine bucket to the rotor disk further comprises positioning at least a portion of the first tip shroud surface radially inward of at least a portion of the second tip shroud second surface.

8. A method in accordance with claim 1 wherein coupling the second turbine bucket to the rotor disk further comprises positioning a portion of the first tip shroud first surface within a portion of the second tip shroud second surface.

9. A method in accordance with claim 1 wherein coupling the second turbine bucket to the rotor disk further comprises coupling the second turbine bucket to the rotor disk such that the first and second surfaces contact during operation of the rotor assembly wherein the second surface is positioned to resist radial outward movement of the first surface.

10. A rotor assembly comprising:
a first turbine bucket comprising a first tip shroud extending from a radially outer end of said first turbine bucket, said first tip shroud comprising a first surface; and
a second turbine bucket comprising a second tip shroud extending from a radially outer end of said second turbine bucket, said second tip shroud positioned circumferentially adjacent to said first tip shroud, said second tip shroud comprising a second surface configured to transfer at least one of a portion of radial loading induced to said second tip shroud to said first tip shroud and a portion of radial loading induced to said first tip shroud to said second tip shroud.

11. An assembly in accordance with claim 10 wherein at least a portion of said second surface is positioned radially inward of at least a portion of said first surface when said first turbine bucket and said second turbine bucket are coupled within said rotor assembly.

12. An assembly in accordance with claim 10 wherein said first surface is configured to be positioned within a portion of said second surface.

13. An assembly in accordance with claim 10 wherein said first surface comprises an overhang portion and said second surface comprises an undercut portion.

14. An assembly in accordance with claim 10 wherein said first surface and second surface are configured to mate substantially flush against each other during operation.

15. A turbine bucket assembly comprising:
a turbine bucket;
a tip shroud extending from a radially outer end of said turbine bucket, said tip shroud comprising a leading edge and an opposing trailing edge such that a first circumferential side and an opposing second circumferential side each extend between said leading edge and said trailing edge, said tip shroud further comprises at least one tip rail extending between said first circumferential side and said second circumferential side; and
a first surface and a second surface each extending along a portion of at least one of said first circumferential side, said at least one tip rail, said leading edge, and said trailing edge, said first and second surfaces are configured to enable radial load transfer.

16. An assembly in accordance with claim 15 wherein said first surface is an undercut portion, and said second surface is an overhang portion such that said undercut and said overhang portions facilitate radial load transfer.

17. An assembly in accordance with claim 15 wherein at least one of said first and second circumferential sides comprises said first surface and said second surface.

18. An assembly in accordance with claim 15 wherein said at least one tip rail comprises said first surface and said second surface.

19. An assembly in accordance with claim 15 wherein at least one of said leading edge and said trailing edge comprises said first surface and said second surface.

20. An assembly in accordance with claim 15 wherein said first surface is configured to be positioned within a portion of said second surface.
